(19) United States
(12) Patent Application Publication
(10) Pub. No.: US 2025/0279106 A1
(43) Pub. Date: Sep. 4, 2025

(54) Audio Signal Upmixer

(71) Applicant: Samsung Electronics Co., Ltd., Suwon-si (KR)

(72) Inventors: Sunil Ganpat Bharitkar, Stevenson Ranch, CA (US); Ricardo Thaddeus Paez Amaro, Puebla (MX)

(21) Appl. No.: 19/069,627

(22) Filed: Mar. 4, 2025

Related U.S. Application Data
(60) Provisional application No. 63/561,103, filed on Mar. 4, 2024.

(51) Int. Cl. G10L 19/008; H04N 21/439

(52) U.S. Cl. CPC G10L 19/008; H04N 21/439

(57) ABSTRACT

In one embodiment, a method includes accessing an audio signal encoded in an m-channel format, where m is 3 or more, and determining a time frequency representation of each of the m channels. The method further includes performing (1) simultaneous multichannel surround ambience extraction and (2) primary component extraction on the m-channel audio signal, using generalized equal-levels ambience extraction; diffusing the extracted surround ambience to an n-channel audio signal, where n is greater than m; assigning each extracted primary component of the m-channel audio signal to a primary component of a channel in the n-channel audio signal; and then obtaining an upmixed n-channel audio signal by (1) performing channel-wise addition of each primary component and ambience component of the n-channel audio signal and (2) applying an inverse time frequency operation to the channel-wise addition.

### PRIORITY CLAIM

This application claims the benefit under 35 U.S.C. § 119 of U.S. Provisional Patent Application No. 63/561,103 filed Mar. 4, 2024, which is incorporated by reference herein.

### TECHNICAL FIELD

This application generally relates to audio-signal upmixers.

### BACKGROUND

Audio content can be encoded and played in a variety of formats. For instance, stereo audio refers to audio encoded into two channels (e.g., a left channel and a right channel). Surround-sound audio refers to the 5.1 audio format, which uses 5 loudspeakers (e.g., a front left speaker, a front right speaker, a center channel, and two rear surround channels) and one subwoofer. Immersive audio refers to the 7.1.4 audio format, which contains the 5.1 speakers and adds two additional loudspeakers (typically between the front and rear speakers of the 5.1 format) and four overhead loudspeakers.

### BRIEF DESCRIPTION OF THE DRAWING

FIG. 1 illustrates an example method for upmixing an m-channel audio signal to an n-channel audio signal.

FIG. 2 illustrates an example implementation of the upmixing method of FIG. 1.

FIG. 3 illustrates an example implementation of the upmixing method of FIG. 1 that also performs 3D spatial rendering of audio corresponding to tracked visual objects.

FIG. 4 illustrates an example computing system.

### DESCRIPTION OF EXAMPLE EMBODIMENTS

Audio originally released in stereo or surround format cannot directly take advantage of immersive sound systems. For example, because many media (e.g., songs, movies, TV shows, video clips, etc.) are recorded using non-immersive audio formats, this means that users cannot obtain the benefits of an immersive (7.1.4) audio system when playing legacy audio content.

Upmixing is an audio processing technique in which the input content of m channels is mapped to n channels, where n>m, thereby utilizing larger sound systems than the original m-channel audio content was originally intended for. However, when upmixing, it is challenging to preserve the spatial scene and timbre of the input audio as closely as possible to what the mixing engineer intended without introducing artifacts in an unrealistic immersive sound environment.

The upmixer of this disclosure provides a Generalized Equal Levels Ambience Extraction (GELAE) technique to perform the up mixing, providing superior spatial and timbral quality relative to existing techniques. Particular embodiments also introduce a correlation-based rear-channel extraction algorithm. The upmixing approaches described herein are not compute intensive and therefore are well-suited to real-time applications.

The existing Equal-Levels Ambience Extraction (ELAE) algorithm assumes a simple signal model

$$\vec{X} = \vec{P} + \vec{A} \qquad ( 1 )$$

Where \vec{X} is the time-frequency representation of a stereo signal, with \vec{P} and \vec{A} its corresponding primary and ambience components, respectively. Assuming, as well, that the primary components in both channels are correlated and the ambience components have equal energy

$$‖ {\vec{A}}_{L} ‖ = ‖ {\vec{A}}_{R} ‖ = {I}_{A} , \qquad ( 2 )$$

it is possible to extract the ambience through a soft-mask α

$$\vec{A} = α \vec{X} \qquad ( 3 )$$

with the help of the relation

$${I}_{A}^{2} = \frac{1}{2} ( {r}_{LL} + {r}_{RR} - \sqrt{{( {r}_{LL} + {r}_{RR} )}^{2} + 4 {\vert {r}_{LR} \vert}^{2}} ) , \qquad ( 4 )$$

where rᵢⱼ is the cross-correlation between signals from channels i and j.

To apply ELAE to surround mixes, one could: i) use ambience from L and R for the frontal scene and from Ls (the left surround channel) and Rs (the right surround channel) for the rear scene; or ii) implement pair-wise ambience extraction, where ELAE is applied iteratively to pairs of contiguous speakers. However, these approaches create issues such as: i) losing some ambience information from the laterals and skipping all ambience information from C; and ii) leading to overestimation when identical ambience signals are coming from more than two speakers at a time.

In contrast, the techniques of this disclose provide multi-channel (3 or more) ambience extraction that overcome these issues. To do so, the techniques of this disclose extend ELAE's capacity to work with an arbitrary number of channels N by using a Generalized Equal-Levels Ambience Extraction (GELAE) technique, described below, for instance to upmix audio in the surround-sound, 5.1 format to audio in the immersive 7.1.4 format.

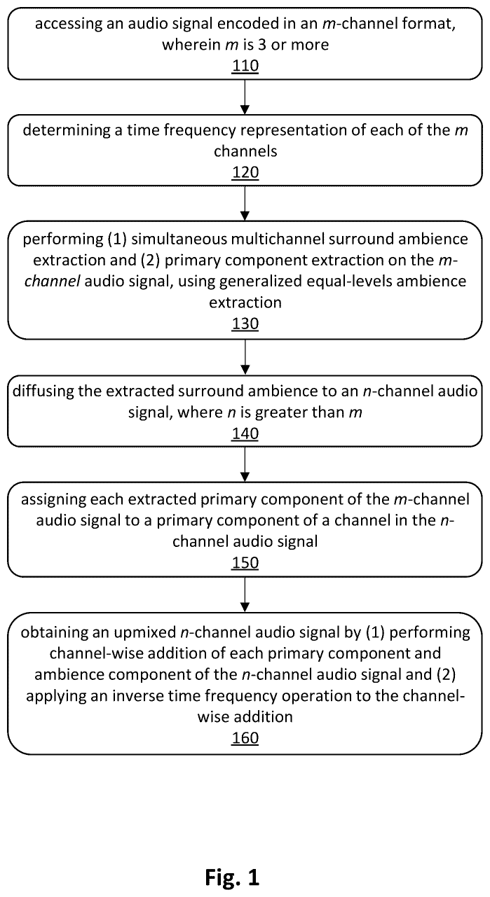

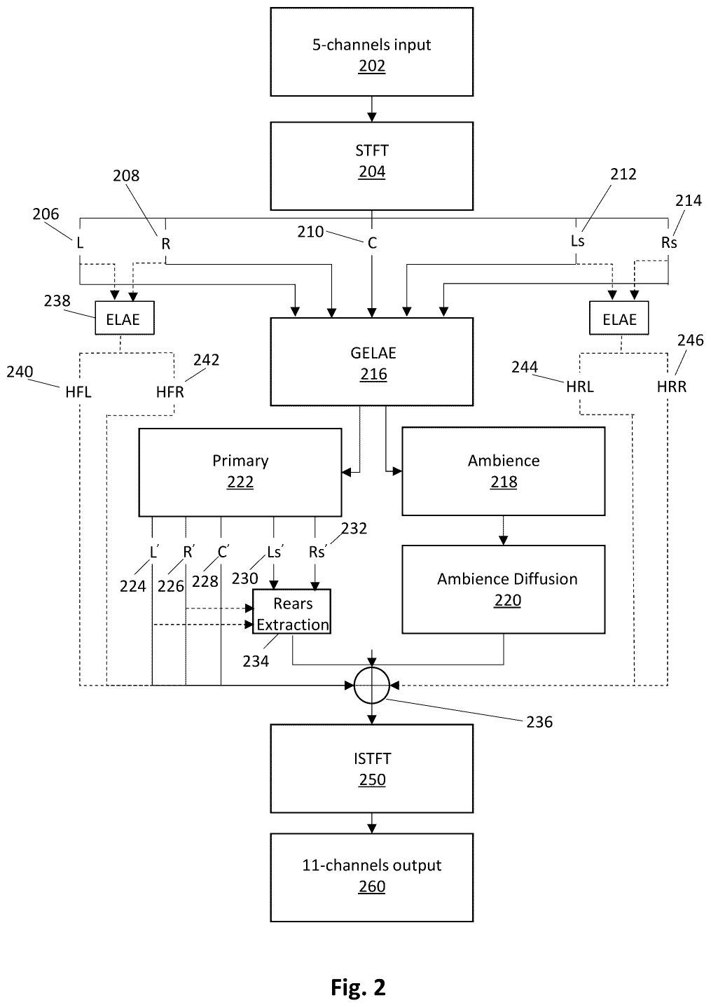

FIG. 1 illustrates an example method for upmixing an m-channel audio signal to an n-channel audio signal, where n>m≥2. FIG. 2 illustrates an example implementation of the upmixing method of FIG. 1, in which a 5.1 surround audio signal is upmixed to an immersive 7.1.4 audio signal.

Step 110 of the example method of FIG. 1 includes accessing an audio signal encoded in an m-channel format, where m is 3 or more. For instance, the m-channel audio signal may be a 5.1-channel audio signal. As illustrated in the example of FIG. 2, the method of FIG. 1 excludes the low-frequency .1 subwoofer channel. For instance, in the example of FIG. 2, the process starts by accessing the 5-channel input 202 of a 5.1 audio signal. As described above, the method of FIG. 1, and the implementation of FIG. 2, may be performed in real-time by an electronic device that is outputting an audio signal for playback. In other words, the example method of FIG. 1 may be performed by a device (e.g., a smart TV, a smartphone, an audio receiver, etc.) as that device is processing the input m-channel audio signal for real-time playback, resulting in a n-channel audio signal being played back.

Step 120 of the example method of FIG. 1 includes determining a time frequency representation of each of the m channels. For instance, FIG. 2 illustrates a time-frequency representation using a Short-Time Fourier Transform (STFT) 204. As an example, step 120 may use a Hanning window with NFFT=1024 and 75% overlap, although other parameters may be used.

Step 130 of the example method of FIG. 1 includes performing (1) simultaneous multichannel surround ambience extraction and (2) primary component extraction on the m-channel audio signal, using generalized equal-levels ambience extraction (GELAE). FIG. 2 illustrates that obtaining a time-frequency representation of the 5-channel input 202 results in the five channels L (left) 206, R (right) 208, C (center) 210, Ls (left surround) 212, and Rs (right surround) 214. From these time-frequency channels, primary components 222 and surround ambience 218 are extracted using GELAE techniques 216, which are described below.

Extending the assumption in eq. 2, above, to all channels results in

$$\begin{matrix}‖ {\vec{A}}_{i} ‖ = {I}_{A} & i = 1 , … N .\end{matrix} \qquad ( 5 )$$

Eq. 4 holds for any pair of channels

$${I}_{A}^{2} = \frac{1}{2} ( {r}_{ii} + {r}_{jj} - \sqrt{{( {r}_{ii} - {r}_{jj} )}^{2} + 4 {\vert {r}_{ij} \vert}^{2}} ) , \qquad ( 6 )$$

where i, j∈{1, . . . . N} and i≠j. To obtain the solution of I_{A} that includes information from all channels, considering the constraint in Eq. 5, add up I_{A}²'s from different channel-pairs and solve for I_{A}². This results in the generalized equation

$${I}_{A}^{2} = \frac{1}{( \begin{matrix}N \\ 2\end{matrix} )} [ {\sum }_{i = 1 , j = 1}^{N - 1 , N} ( 2 {r}_{ii} - \frac{1}{2} \sqrt{{( {r}_{ii} - {r}_{jj} )}^{2} + 4 {\vert {r}_{ij} \vert}^{2}} ) ] \qquad ( 7 )$$

where

$$( \begin{matrix}n \\ k\end{matrix} )$$

is the binomial coefficient for n choose k. Finally, from Eq. 3 and Eq. 5, the techniques herein then find the mask for each channel i with

$${α}_{i} = \frac{‖ {\vec{A}}_{i} ‖}{‖ {\vec{X}}_{i} ‖} = \frac{{I}_{A}}{‖ {\vec{X}}_{i} ‖} . \qquad ( 8 )$$

thus resulting, utilizing Eqs. 2 and 3, in extracted primary components \vec{P} and ambience components \vec{A} for input audio signals that have 3 or more channels.

Step 140 of the example method of FIG. 1 includes diffusing the extracted surround ambience to an n-channel audio signal, where as explained above, n is greater than m. For instance, FIG. 2 illustrates that the extracted surround ambience 218 is then diffused in step 220. As an example, diffusion may occur by randomly spreading the surround ambience to generate 11 new channels, for instance by multiplying a random matrix O∈ [symbol] ^{nxm} times the ambience vector in time t A(t)∈ [symbol] ^{Kxm}, where K is the number of frequency bands in the STFT, taking care that rows of O have unit norm.

Step 150 of the example method of FIG. 1 includes assigning each extracted primary component of the m-channel audio signal to a primary component of a channel in the n-channel audio signal. For instance, in the example of FIG. 2, the extracted primary components of L, C, R, Ls, and Rs are assigned to the new primary channels L′224, C′226, R′228, Ls′230, and Rs′232, respectively, where the ′ superscript refers to the channels for the n-channel audio signal.

Particular embodiments, such as illustrated in FIG. 2, may also use conventional stereo ELAE techniques to extract some additional ambience information. For instance, ELAE techniques 238 may be used on the Land R channels (as the conventional ELAE techniques operate on only two channels) to get frontal ambience sent to HFL and HFR (the front two overhead channels in the 7.1.4 format). Likewise, ELAE techniques 238 are used on the Ls and Rs channels to get rear ambience sent to HRL and HRR (the rear two overhead channels). While particular embodiments may use ELAE techniques in addition to GELAE techniques, other embodiments may omit these ELAE techniques and upmix the n-channel audio using only GELAE techniques.

Particular embodiments may perform immersive rear channels extraction, for example by using channel triads to estimate immersive side and rear channels based on cross-correlation as a similarity measure. In this technique, once the surround ambience has been extracted (e.g., as illustrated in steps 218 and 222 of FIG. 2), the primary components are analyzed to extract the side and rear immersive channels. The following discussion refers to the example of FIG. 2 and uses the subscript 5 when referring to surround audio input and the subscript 7 when referring to the immersive audio input. Therefore, C₅ is the center channel of the surround input while C₇ is the center channel of the immersive output.

There is considerable physical distance between the frontal channels (L₅, C₅, R₅) and the surround rear channels (Ls₅, Rs₅) that might compromise the spatial image of the sound if information were extracted from L₅ and R₅ to be relocated in Ls₇,Rs₇, and Rs₇,Rr₇, respectively. Therefore, instead of drawing energy from the front channels, the immersive rear channels extraction technique exclusively utilizes the energy already present in Ls₅ and Rs₅ to generate the new immersive side and rear channels in step 234 of FIG. 2. However, immersive rear channels extraction also takes into account the similarities between the rear and front-lateral channels (L₅-Ls₅ or R₅-Rs₅), as well as between both rear channels (Ls₅-Rs₅). By selecting channel triplets from the set {(L₅, Ls₅, Rs₅), (R₅, Rs₅, Ls₅)} and comparing the front-lateral with the rear-contralateral similarities at each time step, this technique extracts the corresponding immersive rear and side channels.

Particular embodiments of immersive rear channels extraction use cross-correlation as a similarity measure, although other similarity measure may be used. To construct Ls₇ and Lr₇, particular embodiments take the first triplet (L₅, Ls₅, Rs₅) and compare the cross-correlation of Ls₅ and L₅ (r_{Ls}_{₅}_{L}_{₅}) with the cross-correlation of Ls₅ and Rs₅ (r_{Ls}_{₅}_{Rs}_{₅}), so when the former is larger the corresponding time-frequency tile would be assigned to Ls₇. On the other hand, if the latter is larger, that tile is assigned to Lr₇. If they are both equal, the tile is assigned to both Ls₇ and Lr₇. Particular embodiment may perform this process through masking, as well. The extracting mask for Ls₇ is defined as

$${β}_{L {s}_{7}} = \{ \begin{matrix}1 & {r}_{L {s}_{5} {L}_{5}} \geq {r}_{L {s}_{5} R {s}_{5}} \\ q & {r}_{L {s}_{5} {L}_{5}} < {r}_{L {s}_{5} R {s}_{5}}\end{matrix} , \qquad ( 9 )$$

where q=0.1259 is a constant value corresponding to the attenuation (−18 dB) for each time-frequency tile. Similarly, the corresponding mask for Lr₇ is

$${β}_{L {r}_{7}} = \{ \begin{matrix}1 & {r}_{L {s}_{5} {L}_{5}} \geq {r}_{L {s}_{5} R {s}_{5}} \\ q & {r}_{L {s}_{5} {L}_{5}} < {r}_{L {s}_{5} R {s}_{5}}\end{matrix} . \qquad ( 10 )$$

The derivation of the masks for Rs₇ and Rr7 taking the second triplet (R5, Rs5, Ls5) is

$${β}_{R {s}_{7}} = \{ \begin{matrix}1 & {r}_{R {s}_{5} {R}_{5}} \geq {r}_{R {s}_{5} L {s}_{5}} \\ q & {r}_{R {s}_{5} {R}_{5}} < {r}_{R {s}_{5} L {s}_{5}}\end{matrix} , \qquad ( 11 )$$

$${β}_{L {r}_{7}} = \{ \begin{matrix}1 & {r}_{R {s}_{5} {R}_{5}} \leq {r}_{R {s}_{5} L {s}_{5}} \\ q & {r}_{R {s}_{5} {R}_{5}} > {r}_{R {s}_{5} L {s}_{5}}\end{matrix} . \qquad ( 12 )$$

Step 160 of the example method of FIG. 1 includes obtaining an upmixed n-channel audio signal by (1) performing channel-wise addition of each primary component and ambience component of the n-channel audio signal and (2) applying an inverse time frequency operation to the channel-wise addition. For instance, in the example of FIG. 2, the various inputs for each channel (i.e., primary components, ambience components, and extracted rear channels in the example of FIG. 2) are added on a per-channel basis in step 236 to arrive at the final time-frequency channel representation of the n-channel audio signal. Then, an inverse time frequency operation (e.g., ISTFT 250) is performed to get the time-domain representation 260 of the 11-channel upmixed signal.

Particular embodiments may create an upmixing pipeline on a frame-by-frame approach, where the cross-correlation is calculated at each time frame using a recursive method.

The upmixing techniques described herein provide superior upmixing performance compared to existing techniques, such as Dolby Surround and Neural:X. While the discussion herein and the example of FIG. 2 provide an example in which a 5.1 signal is upmixed to a 7.1.4 signal, the techniques described herein may be applied to upmix any m-channel audio signal, given the condition n>m≥2.

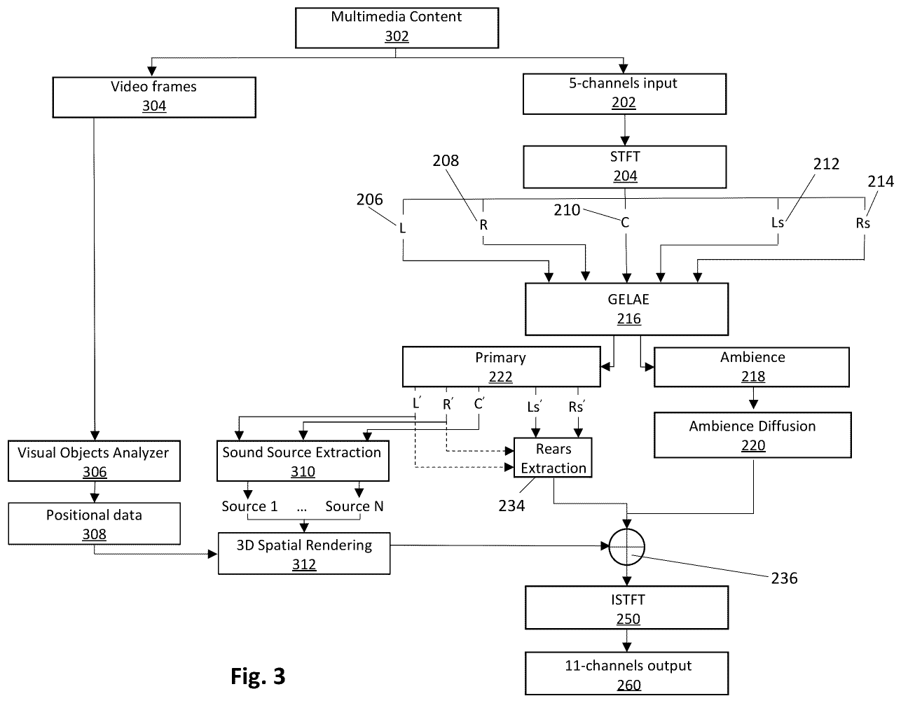

In particular embodiments, visually-guided audio source panning may be included in an upmixing implementation. FIG. 3 illustrates an example implementation of the upmixing method of FIG. 1 that also performs 3D spatial rendering for multimedia content 302, which includes video or other image-based or visual media. For instance, multimedia content 302 may be a movie or TV show playing on a TV. In the example of FIG. 3, 5-channel input 202 is the audio corresponding to the movie or TV show, and the upmixing process for 5-channel input 202 is as described above (although the example of FIG. 3 illustrates a no-ELAE embodiment).

For spatial rendering, frames are extracted from the multimedia content (in the example of FIG. 3, video frames 304 are extracted). A visual objects analyzer 306 identifies one or more objects in video frames 304, for example using an AI model trained to identify objects in an image.

After an object is identified in a frame, then each object's positional data 308 is determined. For instance, each object may be defined by a bounding box (which may not necessarily have a rectangular shape) with known dimensions. The positional data may then be determined using a vector that represents a region (e.g., a top-left corner) of the bounding box. The 2D dimensions (e.g., width and height, for a rectangular bounding box) along with the vector representation define the bounding box's position in the image frame, although other approaches may also be used.

In the example of FIG. 3, sound source extraction 310 involves determining, for each of the N objects identified by visual objects analyzer 306, what portion of the audio for each of the left, right, and center channels corresponds specifically to that object. For instance, suppose a frame's identified objects include a guitar on the left side of the frame, a violin in the middle of the frame, and a trumpet on the right side of the frame. Sound source extraction 310 identifies which portion of the right-channel audio, the left-channel audio, and the center-channel audio corresponds to a guitar, to a violin, and to a trumpet. For instance, the object labels identified in step 306 may be passed to an AI model that is trained to take as input object labels and unsorted audio, and then extract from the audio the specific audio portion (or track) that corresponds to the object. Of course, the AI model would only identify audio for those objects for which it is trained, which may be all or fewer than the N identified objects in the frame. If fewer, then not every object's sound source would be extracted by the trained AI model.

Each sound source is mapped to the corresponding object's positional data 308. Then, 3D spatial rendering 312 maps from the 2D representation on the display to a 3D projection, e.g., to a 3D sphere around the listener. Then, techniques such as VBAP (vector based amplitude panning) may be used to determine the gains for each loudspeaker (e.g., the left, right, and center speakers) to create the 3D projection. In embodiments that use VBAP, each source would have a gain triad, which is then used to adjust the energy of each object's identified audio source, for each loudspeaker channel (e.g., left, right, and center). The gain triad (in this example) is then added, on a per-channel basis, to the corresponding upmixed audio channel in step 236, and the upmixed audio is then processed and output as described above.

As a result of the example of FIG. 3, the audio is upmixed, and the portion of the audio that corresponds to object displayed on the screen are enhanced with spatial rendering. For instance, continuing the example above, the guitar would play more from the left channel, and the trumpet more from the right, while the violin plays more from the center. In the example of FIG. 3, source extraction is performed on the left, right, and center channels because the visual content is (presumably) in front of the viewer, and the left, right, and center channels correspond to the audio that is also in front of the viewer.

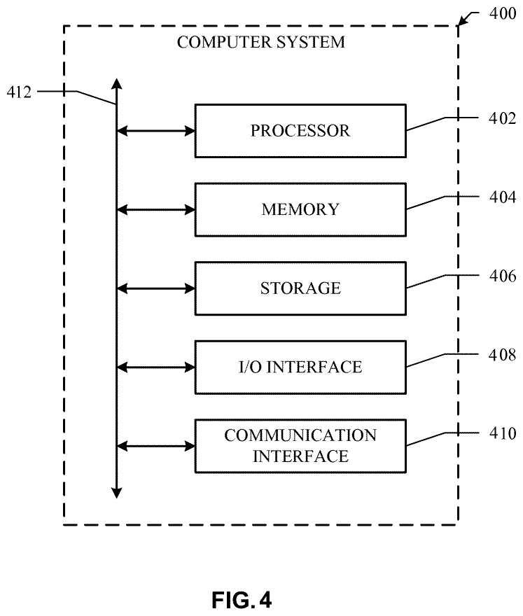

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing an audio signal encoded in an m-channel format, wherein m is 3 or more;
determining a time frequency representation of each of the m channels;
performing (1) simultaneous multichannel surround ambience extraction and (2) primary component extraction on the m-channel audio signal, using generalized equal-levels ambience extraction;
diffusing the extracted surround ambience to an n-channel audio signal, where n is greater than m;
assigning each extracted primary component of the m-channel audio signal to a primary component of a channel in the n-channel audio signal; and
obtaining an upmixed n-channel audio signal by (1) performing channel-wise addition of each primary component and ambience component of the n-channel audio signal and (2) applying an inverse time frequency operation to the channel-wise addition.

2. The method of claim 1, wherein the m-channel format comprises a 5-channel surround format and the n-channel format comprises an 11-channel immersive format.

3. The method of claim 2, further comprising generating immersive rear and side channels in the n-channel audio signal using immersive rear channels extraction.

4. The method of claim 3, further comprising extracting, using equal-levels ambience extraction, (1) frontal ambience for an overhead front left channel and for an overhead front right channel from a left channel and a right channel in the m-channel format and (2) rear ambience for an overhead rear left channel and an overhead rear right channel from a left surround channel and a right surround channel in the m-channel format.

5. The method of claim 3, where the method occurs in response to a request to play the audio signal.

6. The method of claim 5, wherein the method occurs substantially in real time with the request.

7. The method of claim 1, wherein the method is performed by a smart TV.

8. The method of claim 1, wherein the audio signal is part of a multimedia content comprising audio and one or more images; and the method further comprises:
identifying one or more objects in at least some of the one or more images;
determining an image position of each of the identified one or more objects;
determining, for at least some of the one or more objects, a portion of the audio signal that corresponds to that object;
determining, for each of the least some one or more objects, and based on (1) the image position of the object and (2) the portion of the audio signal that corresponds to that object, a spatial rendering for the portion of the audio signal; and
enhancing the n-channel audio signal with each determined spatial rendering.

9. One or more non-transitory computer readable storage media storing instructions that are operable when executed to:
access an audio signal encoded in an m-channel format, wherein m is 3 or more;
determine a time frequency representation of each of the m channels;
perform (1) simultaneous multichannel surround ambience extraction and (2) primary component extraction on the m-channel audio signal, using generalized equal-levels ambience extraction;
diffuse the extracted surround ambience to an n-channel audio signal, where n is greater than m;
assign each extracted primary component of the m-channel audio signal to a primary component of a channel in the n-channel audio signal; and
obtain an upmixed n-channel audio signal by (1) performing channel-wise addition of each primary component and ambience component of the n-channel audio signal and (2) applying an inverse time frequency operation to the channel-wise addition.

10. The media of claim 9, wherein the m-channel format comprises a 5-channel surround format and the n-channel format comprises an 11-channel immersive format.

11. The media of claim 10, wherein the instructions are further operable when executed to generate immersive rear and side channels in the n-channel audio signal using immersive rear channels extraction.

12. The media of claim 11, wherein the instructions are further operable when executed to extract, using equal-levels ambience extraction, (1) frontal ambience for an overhead front left channel and for an overhead front right channel from a left channel and a right channel in the m-channel format and (2) rear ambience for an overhead rear left channel and an overhead rear right channel from a left surround channel and a right surround channel in the m-channel format.

13. The media of claim 11, wherein the instructions are further operable to perform the operations in response to a request to play the audio signal.

14. A system comprising:
one or more non-transitory computer readable storage media storing instructions; and one or more processors coupled to the one or more non-transitory computer readable storage media and operable to execute the instructions to:
access an audio signal encoded in an m-channel format, wherein m is 3 or more;
determine a time frequency representation of each of the m channels;
perform (1) simultaneous multichannel surround ambience extraction and (2) primary component extraction on the m-channel audio signal, using generalized equal-levels ambience extraction;
diffuse the extracted surround ambience to an n-channel audio signal, where n is greater than m;
assign each extracted primary component of the m-channel audio signal to a primary component of a channel in the n-channel audio signal; and
obtain an upmixed n-channel audio signal by (1) performing channel-wise addition of each primary component and ambience component of the n-channel audio signal and (2) applying an inverse time frequency operation to the channel-wise addition.

15. The system of claim 14, wherein the m-channel format comprises a 5-channel surround format and the n-channel format comprises an 11-channel immersive format.

16. The system of claim 15, further comprising one or more processors that are coupled to the media and are operable to execute the instructions to generate immersive rear and side channels in the n-channel audio signal using immersive rear channels extraction.

17. The system of claim 16, further comprising one or more processors that are coupled to the media and are operable to execute the instructions to extract, using equal-levels ambience extraction, (1) frontal ambience for an overhead front left channel and for an overhead front right channel from a left channel and a right channel in the m-channel format and (2) rear ambience for an overhead rear left channel and an overhead rear right channel from a left surround channel and a right surround channel in the m-channel format.

18. The system of claim 16, wherein the one or more processors are further operable to perform the operations in response to a request to play the audio signal.

19. The system of claim 18, wherein the one or more processors are further operable to perform the operations substantially in real time with the request.

20. The system of claim 14, further comprising a smart TV that contains the media and the one or more processors.
